(19) United States
(12) Patent Application Publication
(10) Pub. No.: US 2009/0074334 A1
(43) Pub. Date: Mar. 19, 2009

(54) Concealed Slide Assembly

(76) Inventor: Teng-Yi JUAN, Wuqi Town (TW)

Correspondence Address: HDLS Patent & Trademark Services, P.O. BOX 220746, CHANTILLY, VA, 20153-0746, US

(21) Appl. No.: 11/971,997

(22) Filed: Jan. 10, 2008

(30) Foreign Application Priority Data
Sep. 13, 2007 (TW) 096215411

(51) Int. Cl. F16C 35/04

(52) U.S. Cl. 384/19

(57) ABSTRACT

A concealed slide assembly capable of lowering its manufacturing cost and providing an easier assembling includes a same shaped guiding element and a guide rail element and a first sliding element, and both are installed symmetrically into a substantially S-shaped first bearing bushing. A first bearing bushing made of plastic includes a middle portion accommodated by a space formed by the guide rail element and the first sliding element, a plurality of horizontal and vertical cylindrical roller bearings. The guide rail element and the first sliding element are bent to form corresponding arc guiding grooves for installing a plurality of ball bearings. With the installation of each bearing, the first sliding element can slide with respect to the guide rail element. The first sliding element can use a second bearing bushing installed in the cylindrical roller bearing to slidably install a second sliding element.

### BACKGROUND OF THE INVENTION

1. Field of the Invention

The present invention relates to a concealed slide assembly, and more particularly to a concealed slide for sliding in a closed object such as a drawer.

2. Description of the Prior Art

Concealed slide assembly is used extensively as a drawer slide in various different closed objects such as file cabinets, kitchen cabinets and other furniture. In general, a conventional drawer slide is divided into a three-piece slide that can be fully extended and can bear a heavier load and a two-piece slide that can be extended only up to three quarters of its full length and can bear a lighter load. The conventional three-piece slide usually installs a bearing device in each of the directions of the four corners between an external sliding element and a middle sliding element, and the middle sliding element and an internal guide rail element for bearing a load, reducing worn-outs, as well as sliding between components.

In FIG. 11, a typical prior art three-piece drawer slide comprises an internal guide rail element 91, a middle sliding element 92 and an external sliding element 93. The internal guide rail element 91 is substantially in a rhombus shape and made of a curl-shaped steel material, and its four diagonal positions are inwardly bent to form first arc guiding grooves 911, 912, 913, 914 that serve as a surface for a bearing to travel. The middle sliding element 92 includes an open end 925 for allowing a substantially L-shaped frame 915 that is formed by extending and bending the internal guide rail element 91 to be extended out from the middle sliding element 92, and the frame 915 is provided for fixing the internal guide rail element 91 onto a sidewall surface of a furniture item (not shown in the figure) such as a kitchen cabinet. The middle sliding element 92 is bent into second arc guiding grooves 921, 922, 923, 924 corresponding to the four diagonal positions of the first arc guiding groove 911, 912, 913, 914 and provided for the bearing to travel. The plurality of ball bearings 94 are retained in a ball bearing bushing 96, such that the ball bearing 94 can be rotated and slid between the first and second arc guiding grooves during its operation to allow the middle sliding element 92 to slide with respect to the internal guide rail element 91. Similarly, a ball bearing 97 with a similar structure is installed between the middle sliding element 92 and the external sliding element 93, such that the external sliding element 93 can slide with respect to the middle sliding element 92. The top surface of the middle sliding element 92 further includes an additional lid element 98 bent in an opposite direction in conformity with the external sliding element 93 into two corresponding arc guiding grooves 931, 981 which are provided for the ball bearing 97 to travel. The external sliding element 93 is fixed to the bottom of a drawer (not shown in the figure). With the foregoing slide mechanism, the drawer can be operated to slide with respect to the furniture item.

The structural design of the conventional three-piece drawer slide includes at least four asymmetrical and different shaped components made of a curl-shaped steel material, and these components are an internal guide rail element 91, a middle sliding element 92, an additional lid element 98 and an external sliding element 93. Therefore, different roller machines are required for the roll pressing and shaping, and such arrangement not only incurs a high cost, but also wastes the manufacturing time, or even causes a poor yield rate. Further, the aforementioned conventional three-piece drawer slide requires a stricter precision for the manufacture, and the tolerance range is relatively smaller. If the conventional drawer slide is applied for the manufacture of a wooden drawer that usually comes with a higher production or manufacturing error, the drawer may have the problems such as unsmooth operations of the drawer or interferences to an extent that the drawer cannot be pulled out at all.

### SUMMARY OF THE INVENTION

The primary objective of the present invention is to provide a concealed slide assembly that comes with a simplified structure of a slide mechanism and symmetrical and identical components, and thus a smaller number of roller machines is required for its manufacture to achieve the effects of lowering the equipment cost, reducing the manufacturing time and cost, and improving the yield rate.

A secondary objective of the present invention is to provide a concealed slide assembly, wherein its bearing bushing is made of a plastic material, and thus the invention not only lowers the cost, but also provides an easy assembling process.

Another objective of the present invention is to provide a concealed slide assembly that allows a larger manufacturing tolerance, and such arrangement not only suits the slide mechanism of a metal furniture item, but also suits any other furniture item made of a different material such as wood and maintains a very good physical characteristic for the sliding.

To achieve the foregoing objective, the present invention provides a concealed slide assembly comprising: an internal guide rail element made of a curl-shaped steel plate and a first sliding element, wherein the internal guide rail element includes a guide rail element having an identical shape of the first sliding element and both are symmetrically installed in a first bearing bushing; the first bearing bushing includes a middle portion and a first and second slot hole for installing the guide rail element and the first sliding element, and the middle portion is accommodated in a space formed by the guide rail element and first sliding element. The middle portion installs at least one horizontal cylindrical roller bearing and at least one vertical cylindrical roller bearing, and the guide rail element and the first sliding element are bent into corresponding arc guiding grooves for installing a plurality of ball bearings, so as to slidably install the guide rail element and the first sliding element.

The internal guide rail element further includes a frame with an end coupled to the guide rail element and another end coupled to a furniture item.

In a preferred embodiment of the present invention, the concealed slide assembly further comprises a second sliding element made of a curl-shaped steel plate and at least one second bearing bushing made of plastic, and the second bearing bushing is substantially in an inverted U-shape and tightly sheathed onto an external surface of the first sliding element, and the substantially inverted U-shaped second sliding element is also tightly sheathed onto an external surface of the second bearing bushing. The second bearing bushing installs at least one horizontal cylindrical roller bearing and at least one vertical cylindrical roller bearing for allowing the installed first sliding element, second bearing bushing and second sliding element to slide. The bottom of two sidewalls of the second sliding element is bent inwardly to form two side skirt portions abutted onto the bottom surface of the two sidewalls of the second bearing bushing to prevent the installed components from being separated or fallen out by accident.

### BRIEF DESCRIPTION OF THE DRAWINGS

For a more complete understanding of the invention, reference should be made to the embodiments illustrated in greater detail in the accompanying drawings described below by way of example of the invention:

FIG. 1 is an exploded view of a concealed slide assembly in accordance with a first preferred embodiment of the present invention;

FIG. 2 is an enlarged view of a partial assembly of the concealed slide assembly, wherein a ball bearing is indicated by dotted lines in order to clearly disclose other components;

FIG. 3 is an enlarged front view of the concealed slide assembly;

FIG. 4 is an enlarged longitudinal section view of the concealed slide assembly as depicted in FIG. 3;

FIG. 5 is an enlarged perspective view of a first bearing bushing in the concealed slide assembly;

FIG. 6 is an exploded view of a concealed slide assembly in accordance with a second preferred embodiment of the present invention;

FIG. 7 is a perspective view of the concealed slide assembly in accordance with a second preferred embodiment of the present invention;

FIG. 8 is an enlarged front view of the concealed slide assembly in accordance with a second preferred embodiment of the present invention;

FIG. 9 is an enlarged perspective view of a second bearing bushing in the concealed slide assembly;

FIG. 10 is an enlarged front view of a concealed slide assembly in accordance with a third preferred embodiment of the present invention; and

FIG. 11 is a front view of a prior art three-piece drawer slide.

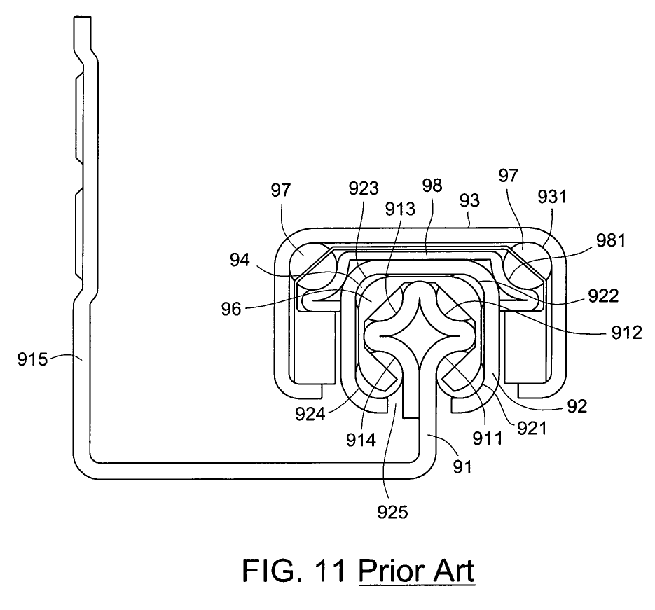

### DETAILED DESCRIPTION OF THE PREFERRED EMBODIMENT

The present invention provides a concealed slide assembly which can be a two-piece drawer slide or a three-piece drawer slide.

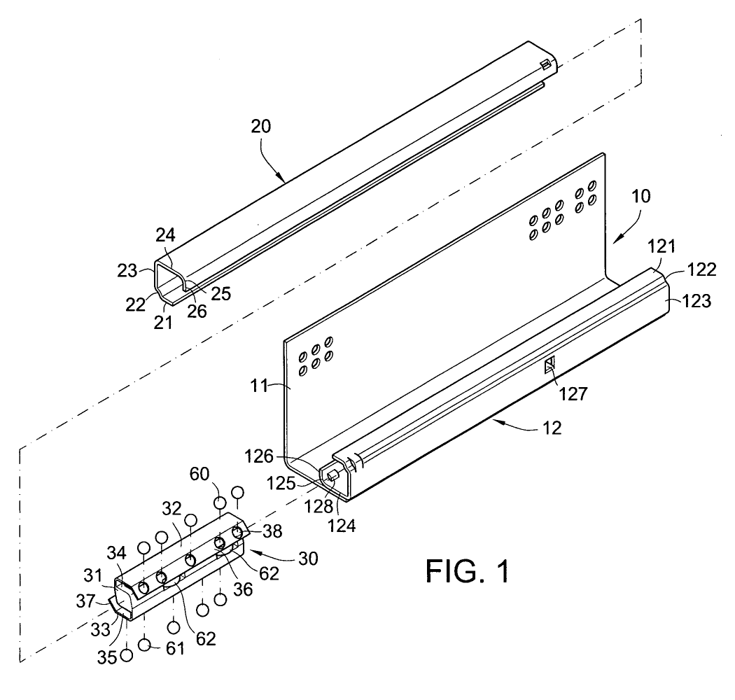

Referring to FIGS. 1 to 5 for a two-piece drawer slide in accordance with the present invention, the drawer slide uses a first bearing bushing 30 to install an internal guide rail element 10 and a first sliding element 20 into a slide mechanism.

The internal guide rail element 10 is made of a curl-shaped steel plate, and includes a frame 11 and a guide rail element 12. An end of the frame 11 is connected to the guide rail element 12 by a method such as welding, and another end is connected to a furniture item 70 by a method such as screw connection.

The first sliding element 20 is also made of a curl-shaped steel plate, and both of the first sliding element 20 and the guide rail element 12 have substantially the same C-shaped cross-section, and thus they can be manufactured by the same roller machine.

The first sliding element 20 includes a bottom horizontal wall 21 bent gradually from bottom to top, an inwardly concave first arc guiding groove 22, a left vertical wall 23, a top horizontal wall 24, a second arc guiding grooves 25 and a right vertical wall 26, and an opening is formed between the right vertical wall 26 and the bottom horizontal wall 21. The guide rail element 12 having the same shape of the first sliding element 20 includes a top horizontal wall 121 bent gradually from top to bottom, an inwardly concave first arc guiding groove 122, a right vertical wall 123, a bottom horizontal wall 124, a second arc guiding grooves 125 and a left vertical wall 126, and an opening is formed between the left vertical wall 126 and top horizontal wall 121.

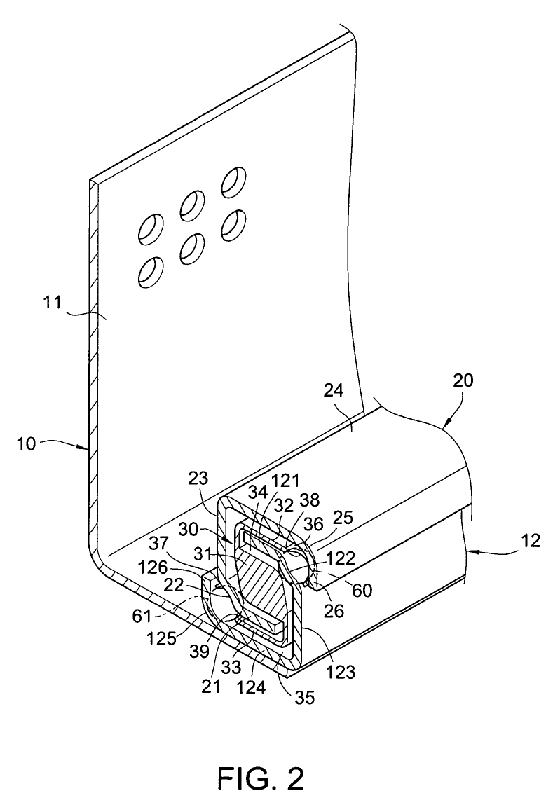

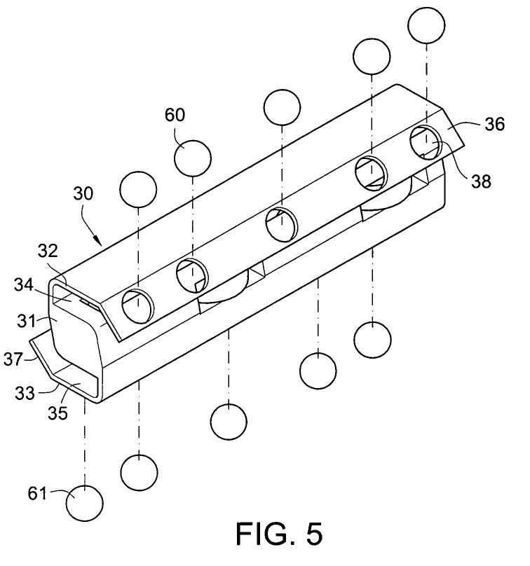

In FIGS. 2 and 5, the cross section of the first bearing bushing 30 is substantially S-shaped, and made by a manufacturing method such as plastic injection molding or plastic steel injection molding. The first bearing bushing 30 includes a substantially tetragonal middle portion 31, an upper slot plate 32 extended upward from an end of the top of the middle portion 31 and then bent to the right, and a lower slot plate 33 extended downward from another end of the bottom of the middle portion 31 and then bent to the left. A gap between the middle portion 31 and the upper slot plate 32 is defined as a first slot hole 34, and a gap between the middle portion 31 and the lower slot plate 33 is defined as a second slot hole 35. The upper slot plate 32 and the lower slot plate 33 are bent at the diagonal positions to form slanting surfaces 36, 37, and the slanting surfaces 36, 37 include a plurality of circular holes 38, 39 for retaining a plurality of ball bearings 60 in the first bearing bushing 30.

In FIGS. 2 to 4, the top horizontal wall 121 of the guide rail element 12 is inserted with sufficient space into a first slot hole 34 of the first bearing bushing 30. On the other hand, the bottom horizontal wall 21 of the first sliding element 20 is inserted with sufficient space into a second slot hole 35 of the first bearing bushing 30. A plurality of ball bearings 60, 61 are retained precisely in a plurality of circular holes 38, 39 at the diagonal positions of the first bearing bushing 30, wherein the plurality of ball bearings 60 situated at the upper diagonal positions are abutted and positioned between the second arc guiding groove 25 of the first sliding element 20 and the first arc guiding groove 122 of the guide rail element 12, and the plurality of ball bearings 61 situated at the lower diagonal positions are abutted and positioned between the first arc guiding groove 22 of the first sliding element 20 and the second arc guiding groove 125 of the guide rail element 12, and the arc guiding grooves 22, 25, 122, 125 are used as traveling surfaces for the plurality of ball bearings 60, 61. The middle portion 31 of the first bearing bushing 30 is accommodated with sufficient space into an internal space 27 enclosed and defined by the guide rail element 12 and the first sliding element 20, and the middle portion 31 installs at least one horizontal cylindrical roller bearing 62 and at least one vertical cylindrical roller bearing 63 for being slidably abutted and positioned between four wall surfaces 21, 23, 121, 123 of the internal space 27. With the installation of each foregoing bearing 60, 61, 62, 63, the first sliding element 20 and the first bearing bushing 30 can slide with respect to the guide rail element 12, and be assembled to form a slide mechanism.

In FIG. 1, the guide rail element 12 includes more than two braking elements 127, 128 for limiting the sliding distance of the first sliding element 20 and the first bearing bushing 30 to prevent the guide rail element 12 from being separated by accident during the sliding process.

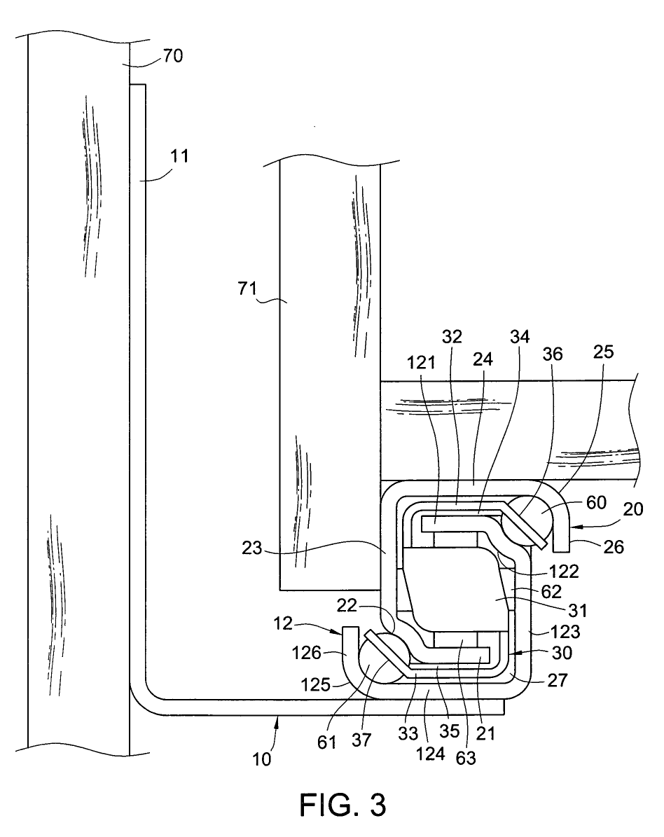

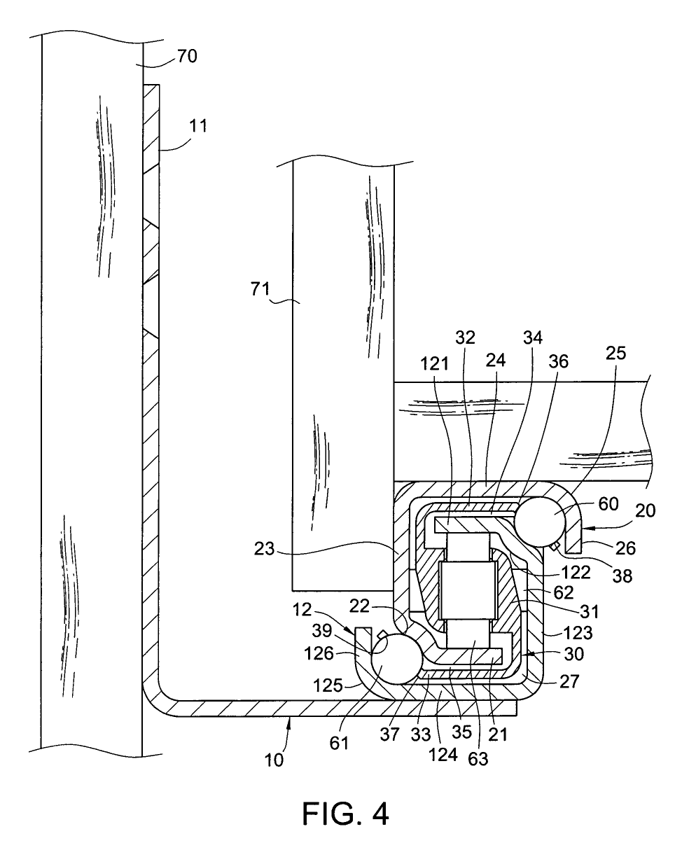

In FIGS. 3 and 4, the external surfaces of the left vertical wall 23 and the top horizontal wall 24 of the first sliding element 20 can be fixed to a drawer 71 by a traditional method, and thus will not be described here.

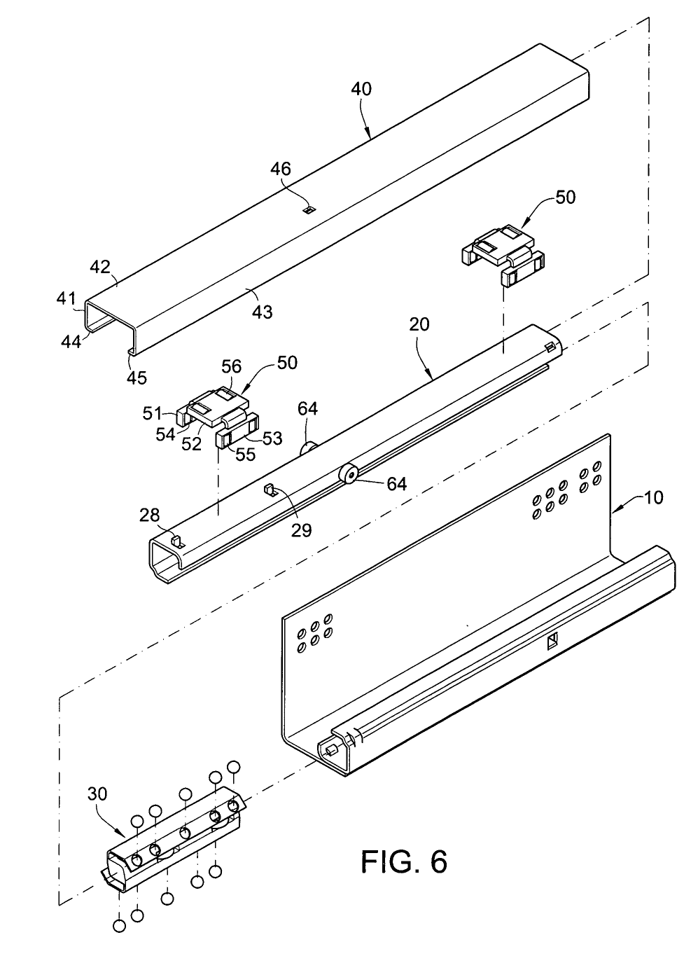

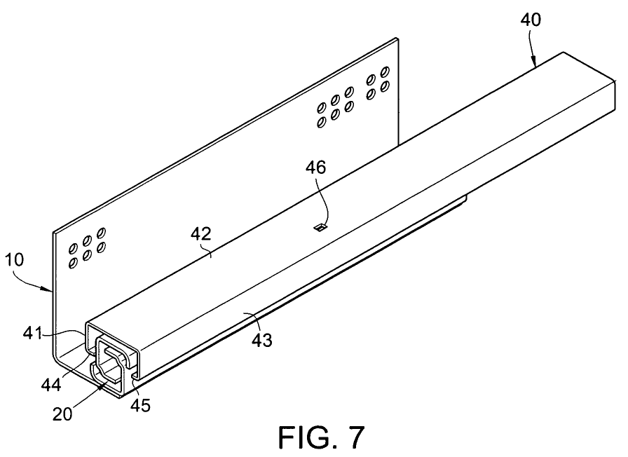

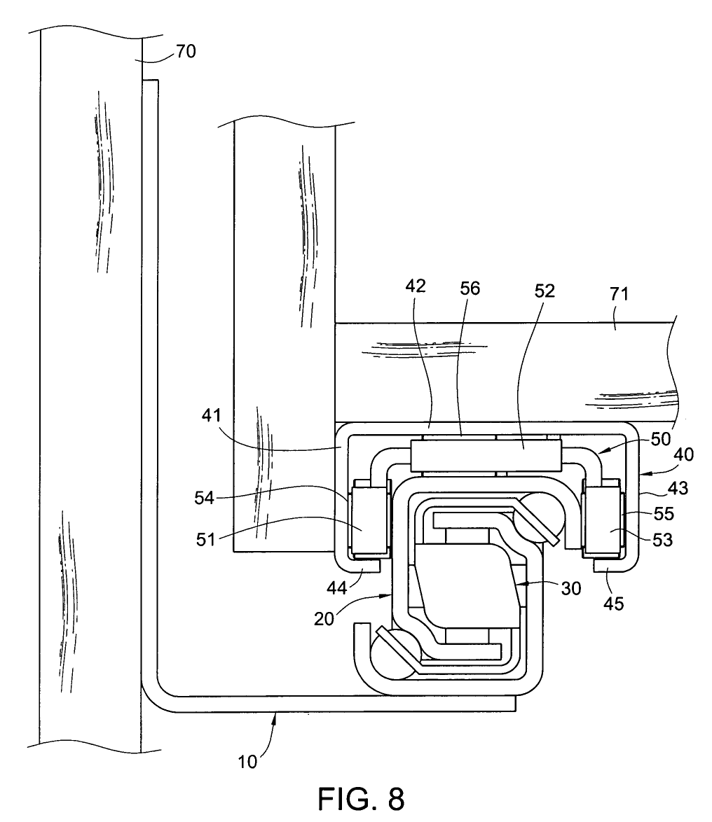

In FIGS. 6 to 9, the three-piece drawer slide in accordance with the present invention bases on the existing structure of a two-piece drawer slide and uses at least one second bearing bushing 50 to slidably install a second sliding element 40 on the top of the first sliding element 20 to constitute a three-piece slide mechanism having two sliding elements.

The internal guide rail element 10, the first sliding element 20 and the first bearing bushing 30 in the three-piece drawer slide are identical with those of the aforementioned two-piece drawer slide, and thus will not be described again.

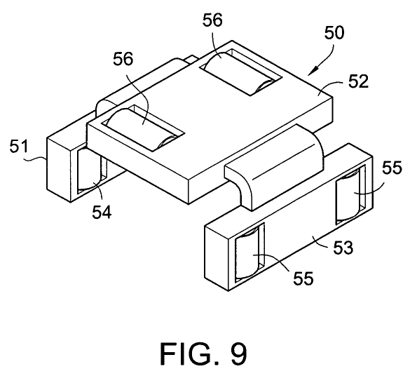

In FIG. 9, cross-section of the second bearing bushing 50 is substantially in an inverted U-shape, and the second bearing bushing 50 is manufactured by a method such as plastic injection molding or plastic steel injection molding. The second bearing bushing 50 includes a left vertical wall 51, a top horizontal wall 52 and a right vertical wall 53 connected with each other, and the two vertical walls 51, 53 install at least one horizontal cylindrical roller bearing 54, 55, and the top horizontal wall 52 installs at least one vertical cylindrical roller bearing 56, such that the second bearing bushing 50 can be slidably sheathed onto the top of the first sliding element 20.

The second sliding element 40 is made of a curl-shaped steel plate and corresponding to the shape of the second bearing bushing 50. The second sliding element 40 includes a left vertical wall 41, a top horizontal wall 42 and a right vertical wall 43 connected with each other. The second sliding element 40 can be sheathed tightly onto an external surface of the second bearing bushing 50. With the installation of each foregoing cylindrical roller bearing 54, 55, 56, the second sliding element 40 and the second bearing bushing 50 can slid with respect to the first sliding element 20, and assembled to constitute a slide mechanism.

The bottoms of the two vertical walls 41, 43 of the second sliding element are bent inward to form left and right side skirt portions 44, 45 for abutting the bottoms of the two vertical walls 51, 53 of the second bearing bushing 50 respectively, so as to further prevent the second sliding element 40 and the second bearing bushing 50 from being separated by accident.

In FIG. 6, the gap between the second sliding element 40 and the first sliding element 20 can be used for installing at least one roller 64, such that the second sliding element 40 can slide more smoothly.

If the present invention is applied for a three-piece drawer slide, the first sliding element 20 further includes more than two braking elements 28, 29, and the second sliding element 40 includes at least one braking element 46 for limiting the sliding distance of the second sliding element 40 and the second bearing bushing 50 to prevent the first sliding element 20 from being separated by accident during the sliding process.

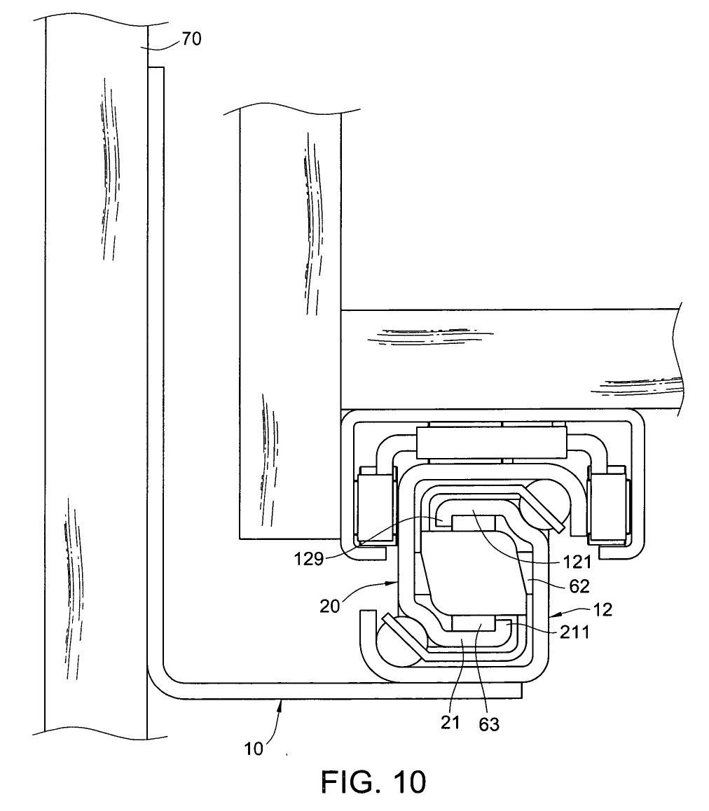

Referring to FIG. 10 for a three-piece drawer slide in accordance with another preferred embodiment of the present invention, a front end of the top horizontal wall 121 of the guide rail element 12 is further bent downward to form a vertical skirt portion 129 for abutting a lateral surface of the vertical cylindrical roller bearing 63. A front end of the bottom horizontal wall 21 of the first sliding element 20 is further bent upward to form a vertical skirt portion 211 for abutting another lateral surface of the vertical cylindrical roller bearing 63 to provide a more secured connection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A concealed slide assembly, comprising:
an internal guide rail element, including a guide rail element;
a first sliding element, having an identical shape and being symmetrically arranged with the guide rail element; and
a first bearing bushing, for installing the guide rail element and the first sliding element which slides with respect to each other, and including a middle portion and upper slot plate and lower slot plate formed by extending and bending top and bottom surfaces of the middle portion in different directions respectively to form a first slot hole between the upper slot plate and the middle portion for inserting a portion of the guide rail element therein, and a second slot hole between the lower slot plate and the middle portion for inserting a portion of the first sliding element therein, and the upper and lower slot plates having a plurality of circular holes for containing and retaining a plurality of ball bearings, and each ball bearing being rollably abutted and positioned between the guide rail element and the first sliding element.

2. The concealed slide assembly as recited in claim 1, wherein the middle portion of the first bearing bushing is accommodated precisely with sufficient space in an internal space formed by enclosing the guide rail element and the first sliding element, and the middle portion further installs at least one horizontal cylindrical roller bearing and at least one vertical cylindrical roller bearing to be slidably abutted and positioned between four wall surfaces that constitutes the internal space.

3. The concealed slide assembly as recited in claim 1, wherein the upper slot plate and the lower slot plate include circular holes disposed at positions proximate to the diagonal positions of open ends of the first and second slot holes.

4. The concealed slide assembly as recited in claim 3, wherein the guide rail element and the first sliding element separately form a symmetric arc guiding groove on a surface in contact with each ball bearing, and the symmetric arc guiding groove serves as a traveling surface for each ball bearing.

5. The concealed slide assembly as recited in claim 1, wherein the internal guide rail element further includes a frame with an end coupled to the guide rail element and another end coupled to a furniture item.

6. The concealed slide assembly as recited in claim 1, wherein the guide rail element includes more than two braking elements for limiting the sliding distance of the first sliding element and the first bearing bushing.

7. The concealed slide assembly as recited in claim 1, further comprising a second sliding element slidably installed on top of the first sliding element, and at least one second bearing bushing, and the second bearing bushing further installing at least one horizontal cylindrical roller bearing and at least one vertical cylindrical roller bearing, and each cylindrical roller bearing being slidably pressed and positioned between the first sliding element and the second sliding element.

8. The concealed slide assembly as recited in claim 7, wherein the second sliding element further includes two side skirt portions, for abutting pressing the second bearing bushing by a separation resisting method.

9. The concealed slide assembly as recited in claim 7, further comprising at least one roller installed between the first sliding element and the second sliding element.

10. The concealed slide assembly as recited in claim 7, wherein the first sliding element and the second sliding element separately include at least one braking element, for limiting the sliding distance of the second sliding element and the second bearing bushing.
